(19) United States
(12) Patent Application Publication
(10) Pub. No.: US 2006/0130398 A1
(43) Pub. Date: Jun. 22, 2006

(54) Three-year method of transforming a lawn into a stable, healthy plant community

(76) Inventors: Shannon Schooling, Georgetown, TX (US); Stewart K. Hanson, Wayzata, MN (US)

Correspondence Address: MERCHANT & GOULD PC, P.O. BOX 2903, MINNEAPOLIS, MN, 55402-0903, US

(21) Appl. No.: 11/148,844

(22) Filed: Jun. 9, 2005

Related U.S. Application Data
(63) Continuation-in-part of application No. 10/688,191, filed on Oct. 16, 2003, now abandoned.
(60) Provisional application No. 60/419,240, filed on Oct. 17, 2002.

(51) Int. Cl. C09K 17/14

(52) U.S. Cl. 47/58.1 SC

(57) ABSTRACT

The invention is a method of transforming a lawn into a stable, healthy plant community that can be maintained as a stable, healthy plant community without use of synthetic, non-organic, non-natural pesticides and fertilizers. The method comprises implementing a three-year, or three entire growing season program, wherein in the first two years, a transition is made to utilization of increasing proportions of organic and natural fertilizers, herbicides and pesticides, and improved biological, natural controls and cultural practices. In the third year or full growing season, the lawn is transformed into being free of synthetic, non-organic fertilizers, herbicides and pesticides through se of organic fertilizers, organic herbicides, organic insecticides, biological and natural controls, and improved cultural practices.

### RELATED APPLICATION

This application is a continuation-in-part patent application of U.S. Ser. No. 10/688,191 filed Oct. 16, 2003 and claims priority under 35 U.S.C. §119(e) to U.S. provisional application Ser. No. 60/419,240 filed on Oct. 17, 2002, these applications incorporated by reference herein.

### FIELD OF THE INVENTION

The present invention relates to lawn care, including home and recreational lawns, and especially relates to a three-year method of transforming a lawn into a stable, healthy plant community that can be maintained as a stable, healthy plant community without use of synthetic, non-organic, non-natural fertilizers, herbicides and pesticides.

### BACKGROUND OF THE INVENTION

It is well known that large turfgrass plant communities, referred to as lawns, are maintained in modern American and Western urban, suburban and rural environments through rigorous cultural practices. Typical cultural practices during a full growing season include regular mowing to maintain a desired height of cut; application of fertilizers to instigate growth of the turfgrasses; application of pre-emergent herbicides to eliminate or minimize growth of annual grass-like, or monocotyledon weeds, such as crab grass; application of post-emergent, contact herbicides to eliminate or minimize growth of broad-leaf, or dicotyledon weeds, such as dandelions, etc.; application of insecticides to control lawn surface-insect pests, such as sod web-worms, cinch bugs, etc., or to control root zone insect pests, such as Japanese Beetle grubs, etc.; application of soil amendatory substances to enhance soil stability, such as lime to control a soil pH; regular irrigation of the plant community with water to supply water to the plants, to water in the aforesaid applied compounds, and to cool the plants; implementation of mechanical cultural practices, such as aerating or “coring” the plant root zone and slicing the plant soil interface to break up and control turfgrass thatch layers; and, over-seeding the plant communities with desirable turf seeds to replace lost turfgrass plants.

Such practices are known to produce desirable recreational lawns for sports activities such as golf, baseball and football, as well as to produce an attractive, valuable home lawn. It has become a multi-billion dollar industry to provide materials for maintenance of attractive lawns, and, especially for home lawns, it has become an enormous industry to provide and maintain fine lawns for homeowners, by regular implementation of the described cultural practices by both homeowners, and by lawn-care vendors.

Unfortunately however, it is also well known that implementation of lawn care programs has produced lawns that are dependent upon those intensive cultural practices. Even worse, such practices are deleterious to the environment because they typically utilize synthetic, soluble, high salt-content fertilizers. Application or inorganic, highly soluble fertilizers, and especially fertilizers that provide nitrogen, has many deleterious effects, especially on the ecosystem of the plant communities targeted for application of the fertilizers, and for adjacent and even far removed ecosystems. Perhaps the most recognized drawback of soluble inorganic fertilizers is leaching of the nutrients into ground water. Whenever water infiltration through a soil exceeds the combination of evaporation of ground water from the soil and transpiration of ground water through a plant community, the excess water moves or leaches below the plant root zone into subterranean water movement to ultimately flow into nearby streams, aquifers, ponds, lakes, rivers, and ultimately the oceans of the world.

Common, synthetic, inorganic nitrogen fertilizers produce solutes such as nitrate and ammonium that freely move with the leachate solution to increase ordinary nitrogen content of the streams, ponds, lakes, etc., which dramatically alters their ecosystems. One well-known effect, frequently referred to as eutrophication, is to enhance algal growth in the streams, ponds and lakes so ultimately the dissolved oxygen content of the water is diminished, thereby decreasing available oxygen for fish and other biological forms so that formerly pristine bodies of water become weed and algae infested, unsightly, unpleasant, and unusable problems for recreational purposes and they also become health problems for adjacent communities.

Even more troublesome than such increased nitrogen content of streams, ponds or lakes, etc., is a concern for such nitrogen solutes in aquifers and human drinking water such as in deep wells, etc. While careful application of inorganic fertilizers may ameliorate some of this well documented problem, the unpredictability of weather conditions always poses a risk of leaching major proportions of soluble, inorganic fertilizer applications into moving ground water, such as by a sudden downpour of an inch or more of water immediately after application of such fertilizers; a very common problem in fine turfgrass culture, such as on golf courses, parks, athletic fields, and home lawns.

Similar and extraordinary problems are associated with massive use by homeowners and lawn care providers of synthetic herbicides, insecticides, fungicides and other pesticides. It has been well documented that widespread use of such compounds poses compelling health risks, where the compounds are frequently adsorbed onto the shoes of children playing upon the lawns, and then transferred into the homeowner's rugs by the same shoes to become long-term household contaminants. The same synthetic herbicides and pesticides also wash off and leach through the homeowners' and recreational lawns to flow into and contaminate the drinking water, streams, lakes and oceans of our world.

Despite these hazards and risks, the value of attractive and playable recreational and home lawns is so substantial, that ongoing usage of synthetic, non-organic fertilizers, herbicides and pesticides is rapidly increasing throughout the Western world. It is common that successful manufacturers of synthetic, non-organic fertilizers, herbicides and pesticides will combine such compounds in one container of granular particles for easy and frequent application. Similarly, successful lawn care vendors will simply apply extravagant, unnecessary amounts of such compounds to the lawns in up-scale communities, knowing that the resulting lawns will likely have an attractive lush appearance, despite the substantial cost, high irrigation requirements, growing dependence of the turfgrass community upon such compounds, and the ever-growing damage to our environment.

Accordingly, there is a need for a method of transforming such lawns from dependence upon synthetic, non-organic, harmful fertilizers, herbicides and pesticides to stable, healthy plant communities that can be maintained as such without need for usage of such harmful, costly compounds.

### DISCLOSURE OF THE INVENTION

The invention is a method of transforming a lawn into a stable, healthy plant community that can be maintained as a stable, healthy plant community without use of synthetic, non-organic, non-natural pesticides and fertilizers. The method comprises implementing a three-year, or three entire growing season program, wherein in the first two years, a transition is made to utilization of increasing proportions of organic and natural fertilizers, herbicides and pesticides, and improved biological, natural controls and cultural practices. In the third year or full growing season, the lawn is transformed into being free of synthetic, non-organic fertilizers, herbicides and pesticides.

The steps of the program include, during a first year or entire growing season, i. implementing a fertilization program utilizing organic-based fertilizers consisting of at least six applications of the organic-based fertilizer to the lawn; ii. implementing a weed control program utilizing optimal herbicides to suppress any weed communities within the lawn; iii. implementing a lawn surface-insect pest control program utilizing optimal insecticides to suppress any lawn surface-insect pests within the lawn.

Next, during a second year or entire growing season, the method includes: i. continuing the fertilization program utilizing organic-based fertilizers consisting of at least six applications of the organic-based fertilizer to the lawn; ii. continuing the weed control program utilizing optimal herbicides to suppress any weed communities within the law; iii. continuing the lawn surface-insect pest control program utilizing optimal insecticides to suppress any lawn insect pests within the lawn; iv. implementing a program of biological and natural controls of any lawn pests and weeds; and, v. implementing a program of organic pre-emergent crab grass control.

Then, during the third year or entire growing season, the method includes: i. implementing a fertilization program utilizing organic fertilizers consisting of at least six applications of the organic fertilizer to the lawn; ii. implementing a weed control program utilizing organic herbicides, including continuing the program of organic pre-emergent crab grass control; and, iii. implementing a lawn surface-insect pest control program utilizing organic insecticides.

In preferred embodiments, each of the three full growing seasons may also include integration additional cultural practices, including a detailed soil analysis to measure any inadequacies of the soil, and to then make soil amendments to improve the inadequacies, such as measuring a soil pH and implementing a liming program to achieve an optimal soil pH; or measuring macro and micronutrients within the soil, and adjusting the fertilization program to adjust for any inadequacies; measuring a soil cation exchange capacity, and amending the soil if necessary to enhance the cation exchange capacity, etc. Additional cultural practices that may be added in each of the full growing seasons include slice seeding optimal turfgrass seeds; regular core aerating of the turfgrass root zone and over-seeding with optimal or nurse turfgrass seeds.

Accordingly, it is a general object of the present invention to provide a method of transforming a lawn into a stable, healthy plant community, that can be maintained as a stable healthy plant community without use of synthetic, non-organic, non-natural fertilizers, herbicides and pesticides.

This and other objects and advantages of the present three-year method of transforming a lawn into a stable, healthy plant will become more readily apparent through the following description.

### DESCRIPTION OF THE PREFERRED EMBODIMENTS

As recited above, the invention is a method of transforming a lawn into a stable, healthy plant community that can be maintained as a stable healthy plant community without use of synthetic, non-organic, non-natural pesticides and fertilizers. The method involves three discrete steps for three consecutive years or entire growing seasons wherein any given turfgrass plant community, or lawn, is brought to maximum health and then transitioned to organic, natural fertilizers, herbicides and pesticides. In the first year or entire growing season, the method includes the step of i. implementing a fertilization program utilizing organic-based fertilizers consisting of at least six applications of the organic-based fertilizer to the lawn; ii. implementing a weed control program utilizing optimal herbicides to suppress any weed communities within the lawn; iii. implementing a lawn surface-insect pest control program utilizing optimal insecticides to suppress any lawn surface-insect pests within the lawn. Additional, optional cultural steps that may be taken during the first year include: iv. performing a detailed soil analysis to measure soil parameters of at least soil pH, buffer pH, organic matter content, thatch layer evaluation, nutrient load, and cation exchange capacity, and amending the soil to optimize those parameters of the soil; v. slice seeding the turfgrass community to integrate into the turfgrass community turfgrass seeds that are optimal for the particular growing environment; vi. core aerating the root zone by removing root zone cores and over-seeding with the optimal turf grass seeds.

For purposes herein, the phrase “organic-based fertilizers” means the fertilizer ranges from 50% to 100% organic matter by weight, and the organic matter may be derived from biosolids, preferably, such as solids recovered from municipal waste water that is treated biologically using beneficial organisms, then dried at high temperature to destroy harmful bacteria, such as biosolids known in the art. Or, the organic matter may be derived from poultry manure, bone meal, or any plant or animal by-product. Such organic matter constituents of the “organic-based fertilizers” are combined with plant food nutrients known in the art to produce a fertilizer having an organic matter content of 50% to 100%, and an acceptable macro-nutrient ratio of preferably about 15% nitrogen, 3% phosphorus, and 7% potassium, which macro-nutrient ratio may vary with known ranges acceptable for turfgrass communities depending upon specific needs of a target turfgrass community.

The phrase “optimal herbicides”, means that the herbicides are those that are available to the public or professional lawn care managers, and that will do the best job of controlling an identified weed within the target turfgrass community. It is to be understood that from a correct botanical perspective, the word “weed” is generally understood under the subjective standard of an “unwanted plant”. However, for purposes herein of developing a stable, healthy turfgrass community, the word “weed” means any plant that will disrupt the stability and health of the desired turfgrass plants. For example, herein “weed” refers to crab grass, dandelions, plantain, chickweed, etc., and other well-known, undesired plants within desirable turfgrass lawns.

Similarly, the phrase “optimal insecticide” is used herein to identify any insecticide generally available to homeowners or professional turfgrass managers that will effectively control insect pests, including synthetic, non-natural, non-organic insecticides. Such “optimal insecticides” may include insecticides that target only lawn surface-insects, or root zone insects, such as grubs, or both. Again, the goal of the present method within the first two years is to utilize all available cultural practices to optimize the health of the target turfgrass community, and to modify or amend the soil if necessary, and to integrate within the soil turfgrass seeds that are best suited for growth in the turfgrass community in light of the identified soil and other environmental stress factors.

By the phrase “slice seeding”, it is meant that a machine commonly referred to within professional turfgrass care as a “slicer-seeder” is utilized that first cuts slices through the living turfgrass plants into the root zone, and then pours into the slices desired turfgrass seeds. It is often the situation that a given turfgrass community requires excess fertilizer, insecticides, herbicides and irrigation because the species or cultivar of growing turfgrass is not optimized for the soil and other environmental conditions. Slice seeding in optimal turfgrass seeds will aid in transitioning the turfgrass community to a stable healthy community without any need for first killing the turf and then planting a new turfgrass community. Slice seeding allows the transition to a more appropriate, optimal turfgrass, such as insect or drought resistant or shade tolerant varieties of turfgrasses while constantly improving the appearance of the target lawn being improved.

By the phrase “core aerating” the turfgrass community, it is meant that a common practice on highly cultured turfgrasses, such as golf course putting greens, is undertaken, wherein an aerating machine utilizes hollow cylinder punches to extract 2-5 inch cores from the soil every few square inches or so to provide passageways for oxygen within the air to enter the root zone, to de-compact root zone soil, to facilitate movement of water into the root zone, to break up a heavy turfgrass thatch layer that is frequently the home of turf pests, etc. The extracted cores may sometimes be broken up and raked back over the soil, or removed, while optimal turfgrass seeds are over-seeded into the cored holes to also assist transitioning to a healthy, stable turfgrass community.

During the second year or entire growth season, the invention includes the step of: i. continuing the fertilization program utilizing organic-based fertilizers consisting of at least six applications of the organic-based fertilizer to the lawn; ii. continuing the weed control program utilizing optimal herbicides to suppress any weed communities within the lawn; iii. continuing the lawn surface-insect pest control program utilizing optimal insecticides to suppress any lawn insect pests within the lawn; iv. implementing a program of biological and natural controls of any lawn pests and weeds; and, v. implementing a program of organic pre-emergent crab grass control. During the second entire growth season, the aforesaid additional cultural practices of performing a detailed soil analysis, slice seeding a core aerating may also be continued, depending upon the requirements of a specific turfgrass community.

By the phrase “biological and natural controls” it is meant herein to include a biological controls release of natural predators of identified turfgrass pests into the target turfgrass community. Such natural predators may include predatory nematodes, parasitic bacteria of insect grubs, etc. The phrase “natural controls” herein means any products that are naturally occurring and considered organic. They may be derived from or consist of animal or plant ingredients without synthetic components, such as essential oils, garlic extracts, pyrethrums, diatomaceous earth, kaolin, enzymes, etc.

The phrase “implementing a program of organic pre-emergent crab grass control” means applying an organic pre-emergent crab grass control compound just prior to germination of crab grass seeds to suppress their growth. Known organic pre-emergent crab grass control compounds may be utilized, such as those based upon corn gluten meal. One such compound is sold under the brand name “ORLAND'S SAFE-T-SEED”, available from the Manning Agricultural Center, Inc., of Manning, Iowa. It is to be understood, that the phrase “implementing a program of... control” does not necessarily mean that the compounds utilized in the described program, (e.g., the organic pre-emergent crab grass control compound) are to be utilized indefinitely. If acceptable control of the insect, weed problem, or soil problem is effectively achieved, it may not be necessary to continue usage of the control compound or cultural practice. Hence, the compound or cultural practice may be discontinued as part of the “programs” identified herein, if it is no longer necessary.

In the third year or entire growing season, the method includes: i. implementing a fertilization program utilizing organic fertilizers consisting of at least six applications of the organic fertilizer to the lawn; ii. implementing a weed control program utilizing organic herbicides, including continuing the program of organic pre-emergent crab grass control; iii. implementing a lawn surface-insect pest control program utilizing organic insecticides; iv. implementing a program of biological control of root zone, grub insect pests; and, v. continuing the program of biological and natural controls.

By the phrase “organic fertilizer”, it is meant that the fertilizer will supply all of its nitrogen macro-nutrient from plant derived sources, such as from soy bean extract, as disclosed in U.S. Pat. No. 6,406,511, that issued on Jun. 18, 2002 to Haim B. Gunner et al. Other components of the “organic fertilizer” will be organic, and may include agricultural plant extracts and/or animal extracts, such as organic fertilizers also available from the Harmony Products, Co., of Chesapeake, Va.

By the phrase “organic herbicides”, it is meant that the organic herbicides will include as an active ingredient a naturally derived, edible by-product extracted from agricultural crops. When applied to actively growing, dicotyledons or broad leaf weeds, the cells within the weeds build up excessive oxygen, and the oxygen build up is toxic to actively growing weeds and they slowly decline in size until they are no longer competitive with the desired turfgrasses. The organic herbicides include betaine (also known as trimethylglycine), humic acid, fulvic acid, proportions of organic fertilizers to heal non-weed plants, and saponins.

By the phrase “biological control of root zone, grub insect pests”, it is meant that use of known biological predators of immature insect grubs is utilized, such as use of nematode microscopic worms. Nematodes attack typically soil-dwelling, root zone insect pests and do not directly effect plants. The nematodes enter the host pest through body openings or through penetration of the body wall. Once inside, they release a bacterium that kiss the host. The nematode continues to reproduce, and offspring seek out additional insect host pests. Such biological controls are safe, pose no threat to the environment, and assist in transitioning the target lawn to a stable, healthy turfgrass community.

As with the first two entire growing seasons, the third entire growing season of the present inventive method may also include the step of utilizing the aforesaid additional cultural practices of performing a detailed soil analysis, slice seeding and core aerating, depending upon the requirements of a specific turfgrass community.

It can be seen that the present described invention of a method of transforming a lawn into a stable, healthy plant community without use of synthetic, non-organic, non-natural pesticides and fertilizers produces enormous benefits for owners and managers of lawns, and also results in dramatic improvements to our environment by eliminating excessive and/or high-salt content, readily soluble fertilizers, damaging and/or hazardous herbicides and pesticides, while constantly increasing the appearance and value of the target lawn.

The invention enables a three year protocol in the lawn care of a lawn involving up to 75% reduction in inorganic chemical applications without loss of lawn quality. Between 50 and 75% reduction can be achieved. In the course of the program the soil is analyzed and them amended to remedy the failings of the chemistry, structure and soil type. In the practice of the methods of the invention, the lawn care involves a 5, 6, or 7-step step protocol used from late winter (a February date) through early winter (a November date). Each step is separated from any adjacent step by about 20 to 50 days.

The invention comprises a first step involving a soil analysis and soil amendments typically done once in a three year protocol. In conducting a soil analysis, a review of the site soil condition is essential during the pretreatment phase. A careful sampling of the site to obtain a representative sample should perform the analysis. Soil samples should be taken at least two-foot intervals and should sample the soil to a depth of about 12 inches. The sampling sites can be in the form of a grid, each point separated from the closest point by a distance of about 2 to 4 feet. In sampling the soil, a significant portion of the soil is taken, the soil can be taken in the form of a cylindrical sample having a diameter of about 2 inches and a depth of about 12 inches. In other words, a soil sample of about 100 to about 300 cubic inches should be taken. Each of the soil samples can be individually analyzed or the soil samples can be combined, carefully mixed to form a uniform mix and a single sample of that soil can be taken for analysis. If the soil is combined to make a representative sample, the location must have a relatively uniform soil in place. If substantial differences occur from place to place in the site, the differences should be noted and representative samples taken from each unique area. The soil should then be analyzed, preferably for pH, organic matter, potassium content, phosphorus content and sulfur. The following sets forth the preferred ranges for each component.

| Soil Parameter | Targets | | |
|---|---|---|---|
| Soil pH | about | 6.2-7.2 | 6-7.3 |
| | neutral | | |
| Organic Matter (%) | 2.5-5 | 2-5.5 | 1-6 |
| Potassium (ppm) | 90-180 | 85-190 | 80-200 |
| Phosphorus (ppm) | 40-60 | 30-70 | 20-75 |

The results of the soil analysis is then compared to the table set forth above and the site is then amended to return the soil to its optimal characteristics. The amendments can include the addition of pH modifying compositions, the introduction of organic matter in the form of peat moss, straw, compost or other organic sources and either an organic or chemical source of potassium, phosphorus and nitrogen. Such nitrogen can be in the form of chemical urea nitrogen or in the form of an organic nitrogen source such as manure, etc.

Once the soil has been analyzed and amended to obtain an optimized site, the texture of the soil should be analyzed for determining sand content, silt content, clay content and particle size. An attempt to introduce quality soil components can be obtained by blending a top soil into the site to obtain the appropriate amount of sand, silt, clay and soil content. Once the amendments are complete, the organic matter should be tested to ensure that the turf has from about 1 to about 10% organic matter, preferably about 2-8%. If the preceding soil amendment program is successfully completed, the soil should obtain and maintain a beneficial moisture content that can promote excellent growth and growth through water retention and water release into the plant roots. This soil analysis and amendment can be done in a first calendar year or in the early spring of a second calendar year. However, the soil analysis and amendment is typically followed by a 3 year program of a 6 step treatment protocol. At the end of the program, the site should have obtained an optimized appearance while requiring the minimum organic and inorganic fertilizer application to maintain quality appearance. In a cool season 6 step program, the following steps can be followed depending on desired application rates.

Cool Season Lawn Maintenance Program
6-Step protocol with a 75% chemical use reduction lawncare Application Program

| Step 1 Early Spring Energizer | Date: Mid February | |
|---|---|---|
| Fertility Program | Fertilizer 10 to 20-1 to 5-2 to 8 Rate: 3-10 lbs. per 1000 sq. ft. | |
| Benefits: | □ Excellent Color | □ Cool Temperature Release |
| | □ Annual Grass Control | □ Enhanced Rooting |
| Step 2 Spring Enhancer | Date: April | |
| Fertility Program | Fertilizer 10 to 20-1 to 5-2 to 8 Rate: 3-10 lbs. per 1000 sq. ft. | |
| Post Weed Control | Spot Application for Annual Grass & Broadleaf Weed Control | |
| Benefits: | □ Builds Microbes | □ Selective Control of Annual |
| | | Grass & Broadleaf Weeds |
| | □ Color with Slow Growth | □ Builds Roots for Summer Stress |
| Step 3 Early Summer Guard | Date: Mid May | |
| Fertility Program | Fertilizer 10 to 20-1 to 5-2 to 8 Rate: 1-5 lbs. per 1000 sq. ft. | |
| Post Weed Control | Spot Application with Broadleaf Weed Control | |
| Benefits: | □ Excellent Color | □ Aids With Disease Management |
| | □ Improved Turf Density | □ Improves Turf Stress |
| Step 4 Summer Stress | Date: July | |
| Fertility Program | Fertilizer 10 to 20-1 to 5-2 to 8 Rate: 1-5 lbs. per 1000 sq. ft. | |
| Post Weed Control | | |
| Benefits: | □ Excellent Color | □ Non-Burning - Summer Safe |
| | □ Reduces Turf Stress | □ Provides Low Salt Nutrients |
| Step 5 Early Fall Recovery | Date: Mid September | |
| Fertility Program | Fertilizer 10 to 20-1 to 5-2 to 8 Rate: 3-10 lbs. per 1000 sq. ft. | |
| Post Weed Control | | |
| Benefits: | □ Provides Fall Color | □ Improves Rooting |
| | □ Enhances Recovery | □ Aids with Turf Density |
| Step 6 Late Fall Winterizer | Date: November | |
| Fertility Program | Fertilizer 10 to 20-1 to 5-2 to 8 Rate: 3-10 lbs. per 1000 sq. ft. | |
| Pre-Emergence | Blanket Application of Barricade | |
| Post Weed Control | Blanket Application with Broadleaf Weed Control | |
| Benefits: | □ Excellent Fall Color | □ Improves Rooting |
| | □ Post Control of Weeds | □ Aids with Spring Color |

6-Step protocol with a 50% chemical use reduction lawncare Application Program

| | |
|---|---|
| Step 1 Early Spring Energizer | Date: Mid February |
| Fertility Program | Nitrogen Fertilizer + Pre-Emergence Rate: 1 lb. N/1000 ft² |
| Pre-Emergence | Dimension |
| Benefits: | Excellent color |
| | Cool Temperature Release |
| | Annual Grass Control |
| | Enhanced Rooting |
| Step 2 Spring Enhancer | Date: April |
| Fertility Program | Fertilizer 10 to 20-1 to 5-2 to 8 Rate: 4-10 lbs. per 1000 sq. ft. |
| Post Weed Control | Blanket Application With Broadleaf Weed Control |
| Benefits: | Builds Microbes |
| | Controls Broadleaf Weeds |
| | Color with Slow Growth |
| | Builds Roots for Summer Stress |
| Step 3 Summer Guard | Date: Mid May |
| Fertility Program | Fertilizer 10 to 20-1 to 5-2 to 8 Rate: 2-5 lbs. per 1000 sq. ft. |
| Post Weed Control | Spot Spray Weeds |
| Benefits: | Excellent Color |
| | Aids With Disease Management |
| | Improved Turf Density |
| | Improves Turf Stress |
| Step 4 Summer Stress | Date: July |
| Fertility Program | Fertilizer 10 to 20-1 to 5-2 to 8 Rate: 2-5 lbs. per 1000 sq. ft. |
| Post Weed Control | |
| Benefits: | Excellent Color |
| | Non-Burning - Summer Safe |
| | Reduces Turf Stress |
| | Provides Low Salt Nutrients |
| Step 5 Early Fall Recovery | Date: Mid September |
| Fertility Program | Fertilizer 10 to 20-1 to 5-2 to 8 Rate: 4-10 lbs. per 1000 sq. ft. |
| Post Weed Control | |
| Benefits: | Provides Fall Color |
| | Improves Rooting |
| | Enhances Recovery |
| | Aids with Turf Density |
| Step 6 Late Fall Winterizer | Date: November |
| Fertility Program | Fertilizer 10 to 20-1 to 5-2 to 8 Rate: 4-10 lbs. per 1000 sq. ft. |
| Pre-Emergence | Blanket Application of Barricade |
| Post Weed Control | Blanket Application with Broadleaf Weed Control |
| Benefits: | Excellent Fall Color |
| | Improves Rooting |
| | Post Control of Weeds |
| | Aids with Spring Color |

In a warm site program, the following steps can be taken depending on the amount of fertilizer desired for application.

6-Step protocol with a 75% chemical use reduction lawncare Application Program

| | | |
|---|---|---|
| Warm Season Lawn Maintenance Program | | |
| Step 1 Early Spring Energizer | Date: Mid February | |
| Fertility Program | Potassium + Pre-Emergence | Rate: 0.5 lb. K/1000 ft² |
| Pre-Emergence | Dimension | |
| Benefits: | | |
| Excellent Color | | |
| Cool Temperature Release | | |
| Annual Grass Control | | |
| Enhanced Rooting | | |
| Step 2 Spring Enhancer | Date: April | |
| Fertility Program | NH₄SO₄ | Rate: 5 lbs. per 1000 sq. ft. |
| Post Weed Control | Spot Spray Annual Grass & Broadleaf Weeds | |
| Benefits: | | |
| Builds Microbes | | |
| Controls Broadleaf Weeds | | |
| Color with Slow Growth | | |
| Builds Roots for Summer Stress | | |
| Step 3 Early Summer Guard | Date: Mid May | |
| Fertility Program | Fertilizer 10 to 20-1 to 5-2 to 8 | Rate: 2-8 lbs. per 1000 sq. ft. |
| Post Weed Control | Spot Spray Weeds | |
| Benefits: | | |
| Excellent Color | | |
| Aids With Disease Management | | |
| Improved Turf Density | | |
| Improves Turf Stress | | |
| Step 4 Summer Stress | Date: July | |
| Fertility Program | Fertilizer 10 to 20-1 to 5-2 to 8 | Rate: 2-8 lbs. per 1000 sq. ft. |
| Post Weed Control | | |
| Benefits: | | |
| Excellent Color | | |
| Non-Burning—Summer Safe | | |
| Reduces Turf Stress | | |
| Provides Low Salt Nutrients | | |
| Step 5 Early Fall Recovery | Date: Mid September | |
| Fertility Program | Fertilizer 10 to 20-1 to 5-2 to 8 | Rate: 2-8 lbs. per 1000 sq. ft. |
| Post Weed Control | | |
| Benefits: | | |
| Provides Fall Color | | |
| Improves Rooting | | |
| Enhances Recovery | | |
| Aids with Turf Density | | |
| Step 6 Late Fall Winterizer | Date: November | |
| Fertility Program | Phosphorous | Rate: 3 lbs. (50% P) per 1000 sq. ft. |
| Pre-Emergence | Blanket Application of Barricade | |
| Post Weed Control | Blanket Application with Broadleaf Weed Control | |
| Benefits: | | |
| Winter Stress Guard | | |
| Builds Root Energy Reserves | | |
| Post Control of Weeds | | |
| Aids with Weed Control | | |

6-Step protocol with a 50% chemical use reduction lawncare Application Program

| | | |
|---|---|---|
| Warm Season Lawn Maintenance Program | | |
| Step 1 Early Spring Energizer | Date: Mid February | |
| Fertility Program | Potassium + Pre-Emergence | Rate: 0.5 lb. K/1000 ft² |
| Pre-Emergence | Dimension | |
| Benefits: | | |
| Excellent Color | | |
| Cool Temperature Release | | |
| Annual Grass Control | | |
| Enhanced Rooting | | |
| Step 2 Spring Enhancer | Date: April | |
| Fertility Program | NH₄SO₄ | Rate: 1-10 lbs. per 1000 sq. ft. |
| Post Weed Control | Blanket Application of Annual Grass & Broadleaf Weed Control | |
| Benefits: | | |
| Builds Microbes | | |
| Controls Broadleaf Weeds | | |
| Color with Slow Growth | | |
| Builds Roots for Summer Stress | | |
| Step 3 Early Summer Guard | Date: Mid May | |
| Fertility Program | Fertilizer 10 to 20-1 to 5-2 to 8 | Rate: 2-6 lbs. per 1000 sq. ft. |
| Post Weed Control | Spot Spray Weeds | |
| Benefits: | | |
| Excellent Color | | |
| Aids With Disease Management | | |
| Improved Turf Density | | |
| Improves Turf Stress | | |
| Step 4 Summer Stress | Date: July | |
| Fertility Program | Fertilizer 10 to 20-1 to 5-2 to 8 | Rate: 2-6 lbs. per 1000 sq. ft. |
| Post Weed Control | | |
| Benefits: | | |
| Excellent Color | | |
| Non-Burning—Summer Safe | | |
| Reduces Turf Stress | | |
| Provides Low Salt Nutrients | | |
| Step 5 Early Fall Recovery | Date: Mid September | |
| Fertility Program | Fertilizer 10 to 20-1 to 5-2 to 8 | Rate: 2-6 lbs. per 1000 sq. ft. |
| Post Weed Control | | |
| Benefits: | | |
| Provides Fall Color | | |
| Improves Rooting | | |
| Enhances Recovery | | |
| Aids with Turf Density | | |
| Step 6 Late Fall Winterizer | Date: November | |
| Fertility Program | Phosphorus | Rate: 1-5 lbs. (50% P) per 1000 sq. ft. |
| Pre-Emergence | Blanket Application of Barricade | |
| Post Weed Control | Blanket Application with Broadleaf Weed Control | |
| Benefits: | | |
| Winter Stress Guard | | |
| Builds Root Energy Reserves | | |
| Post Control of Weeds | | |
| Aids with Weed Control | | |

The above protocol should be conducted over three years to obtain the optimal site growth fungal resistance, insect resistance, weed resistance and optimal color and texture of grass. The long care protocol set forth above enables the lawn to be maintained with up to 100% organic components or from about 25% to about 80% organic components with the balance being inorganic sources of nitrogen, potassium and phosphorus obtaining a reduction is inorganic usage.

While the present invention has been described with respect to particular examples of a method of transforming a lawn into a stable, healthy, plant community, it is to be understood that the invention is not to be limited to the described examples. Consequently, reference should be made primarily to the following claims rather than the foregoing description to determine the scope of the invention.

I claim:

1. A method of lawn care that obtains a transformation of a lawn into a stable, healthy plant community, that can be maintained as a stable, healthy plant community with minimal use of non-organic, non-natural pesticides, herbicides or fertilizers in a period continuing for at least 3 years, the method comprising the steps of:
(a) conducting a soil analysis and correcting soil structure, soil content and at least soil pH, organic content, potassium and phosphorus levels; and
(b) initiating a 5-7 step treatment protocol over each of at least a 3 year program, each step separated by a period of 20-40 days, each step comprising the application of a fertilizer comprising an NPK value of 10 to 20-1 to 5-2 to 6 at a rate of 3-10 lbs. per 1000 ft², the process further comprising in a step 1 through 3 of the 5-7 step protocol, the spot application of annual grass and broadleaf weed control; and the process further comprising in a step after step 4 of the 5-7 step protocol, at least one application of a blanket application of a broadleaf weed control.

2. The method of claim 1 wherein there are 6 steps per year in each of 3 years.

3. The method of claim 1 wherein the maintenance protocol is conducted in a warm season lawn characterized by 1-45 days of below 30° F. nighttime temperatures and wherein the steps 1-3 of the program involves the application of a potassium fertilizer at a rate of 0.1 to 1 lbs. of potassium per 1000 ft² and a pre-emergence weed inhibitor along with the application of an ammonium sulfate fertilizer at a rate of about 1 to 10 lbs. per 1000 ft² at least 20 days after the potassium application.

4. The method of claim 1 wherein the 6 step protocol is conducted in February, April, May, July, September and November.

5. The method of claim 1 maintenance protocol is conducted in a cool season lawn characterized by the occurrence of greater than 45 days of below 32° F., low temperatures during the year wherein the initial application of fertilizer is conducted with a balanced fertilizer at a rate of 3 to 10 lbs. per 1000 ft².

6. A method of transforming a lawn into a stable, healthy plant community that can be maintained as a stable, healthy plant community without use of synthetic, non-organic, non-natural-pesticides, herbicides, or fertilizers, comprising the steps of:
(a) during a first entire growing season,
(i) implementing a fertilization program utilizing organic-based fertilizers consisting of at least six applications of the organic-based fertilizer to the lawn;
(ii) implementing a weed control program utilizing optimal herbicides to suppress any weed communities within the lawn;
(iii) implementing a lawn surface-insect pest control program utilizing optimal insecticides to suppress any lawn surface-insect pests within the lawn;
(b) then, during a second entire growing season, following the first entire growing season;
(i) continuing the fertilization program utilizing organic-based fertilizers consisting of at least six applications of the organic-based fertilizer to the lawn;
(ii) continuing the weed control program utilizing optimal herbicides to suppress any weed communities within the lawn;
(iii) continuing the lawn surface-insect pest control program utilizing optimal insecticides to suppress any lawn insect pests within the lawn;
(iv) implementing a program of biological and natural controls of any lawn pests and weeds;
(v) implementing a program of organic pre-emergent crab grass control; and,
(c) then, during the third entire growing season, after the first and second entire growing seasons;
(i) implementing a fertilization program utilizing organic fertilizers consisting of at least six applications of the organic fertilizer to the lawn;
(ii) implementing a weed control program utilizing organic herbicides, including continuing the program of organic pre-emergent crab grass control; and,
(iii) implementing a lawn surface-insect pest control program utilizing organic insecticides.

7. The method of transforming a lawn of claim 6, comprising the further steps of, during the first entire growing season: performing a detailed soil analysis to measure soil parameters of the soil pH, buffer pH, organic matter content, thatch layer composition, nutrient load, cation exchange capacity and amending the soil to optimize those soil parameters for optimal turfgrass growth; slice seeding the lawn to integrate into the lawn turfgrass community turfgrass seeds that are optimal for the lawn; and, core aerating a root zone of the lawn by removing root zone cores and over-seeding with optimal turfgrass seeds.

8. The method of transforming a lawn of claim 7, comprising the further steps of, during the second entire growing season: performing a detailed soil analysis to measure soil parameters of the soil pH, buffer pH, organic matter content, thatch layer composition, nutrient load, cation exchange capacity and amending the soil to optimize those soil parameters for optimal turfgrass growth; slice seeding the lawn to integrate into the lawn turfgrass community turfgrass seeds that are optimal for the lawn; and, core aerating a root zone of the lawn by removing root zone cores and over-seeding with optimal turfgrass seeds.

9. The method of transforming a lawn of claim 8, comprising the further steps of, during the third entire growing season: performing a detailed soil analysis to measure soil parameters of the soil pH, buffer pH, organic matter content, thatch layer composition, nutrient load, cation exchange capacity and amending the soil to optimize those soil parameters for optimal turfgrass growth; slice seeding the lawn to integrate into the lawn turfgrass community turfgrass seeds that are optimal for the lawn; and, core aerating a root zone of the lawn by removing root zone cores and over-seeding with optimal turfgrass seeds.

10. The method of transforming a lawn of claim 6, comprising the further steps of, during the third entire growing season: implementing a program of biological control of root zone, grub insect pests; and, continuing the program of biological and natural controls.
